(19) United States
(12) Patent Application Publication
(10) Pub. No.: US 2023/0373125 A1
(43) Pub. Date: Nov. 23, 2023

(54) Scrap Trimming and Sizing Method

(71) Applicant: TMS International Corporation, Pittsburgh, PA (US)

(72) Inventors: Joseph H. Jung, Mason, OH (US); Timothy G. Schutz, Grafton, OH (US); Jean-Luc Koclejda, Port Charlotte, FL (US); Philippe Rovel, Villers Les Nancy (FR)

(21) Appl. No.: 18/221,444

(22) Filed: Jul. 13, 2023

Related U.S. Application Data
(63) Continuation of application No. 16/891,466, filed on Jun. 3, 2020.
(60) Provisional application No. 62/856,816, filed on Jun. 4, 2019.

(51) Int. Cl. B26D 7/18; B23D 31/00; B23D 33/00

(52) U.S. Cl. CPC B26D 7/18; B23D 31/001; B23D 33/00

(57) ABSTRACT

A method of trimming and sizing a metal piece. A trimming and sizing apparatus including a travel way, at least one cutting torch assembly having a trimming cutting torch and sectioning cutting torch, and at least one table. A substantially rectangular metal piece is placed on the table. The cutting assembly is traversed along the travel way and the trimming cutting torch makes a longitudinal cut in the metal piece creating a scrap piece. Simultaneously with the cutting of the scrap piece by the trimming cutting torch, the sectioning cutting torch is rotated in an arc around the trimming cutting torch such that the sectioning cutting torch is simultaneously moved in the longitudinal direction and in an arc around the trimming cutting torch creating a cut in the scrap piece such that a sized scrap piece having a desired length/weight is completely removed from the scrap piece.

### CROSS-REFERENCE TO RELATED APPLICATIONS

The present application is a continuation application of U.S. patent application Ser. No. 16/891,466 filed Jun. 3, 2020, which claims priority to U.S. Provisional Patent Application No. 62/856,816, filed Jun. 4, 2019, the disclosures of which are hereby incorporated in their entireties by reference.

### BACKGROUND OF THE INVENTION

### Field of the Invention

The present invention relates to scrap trimming and sizing apparatus for removing scrap pieces from large metal pieces to change the size and/or shape of the large metal pieces and, more particularly, to a scrap trimming and sizing machine that allows for simultaneous removal and sectioning of the scrap pieces.

### Description of Related Art

In the metals industry, it is often necessary to change the size and or shape of a substantially rectangular piece of metal, for example, a metal slab or plate. Most commonly, the width of the piece of metal in the transverse (short side) direction needs to be reduced. It is, therefore necessary to remove material from the longitudinal (long) side of the piece of metal. Such a practice is often referred to as sizing or trimming.

During sizing/trimming, a long, narrow piece of scrap metal is removed from the slab or plate. Such long narrow pieces of metal are often not suitable for recycling or remelting and need to be cut into smaller pieces in a second operation. Most commonly, such a sectioning operation may include manual torch cutting or shearing of the long, narrow piece of scrap metal into smaller pieces. Such operations are time consuming and add labor and equipment cost.

Thus, there is need for an apparatus and method in which the sizing/trimming and the sectioning of the scrap metal that is generated during the sizing/trimming can be completed in one step at higher production rates and with less labor and equipment costs.

The present invention is directed to a torch cutting machine 10 for cutting metal pieces, such as steel slabs and plates, in order to change the dimensions and/or shape of the metal piece while simultaneously sectioning the removed metal scrap pieces for recycling.

### SUMMARY OF THE INVENTION

The present invention is directed to a trimming and sizing apparatus for removing material from a metal piece. The apparatus comprises a travel way, a cutting assembly, and at least one table for holding the metal piece that is being cut, wherein the table is substantially rectangular such that the table is longer in a longitudinal direction than in a transverse direction. The cutting assembly comprises a carriage that travels along the travel way, a boom extending from the carriage in a direction perpendicular to the travel way, at least one cutting torch assembly extending from the boom and comprising a first trimming cutting torch and a second sectioning cutting torch, and a motor that rotates the second sectioning cutting torch with respect to the first trimming cutting torch. The motor rotates the second sectioning cutting torch from a first position in which the second sectioning cutting torch is located offset from and behind the first trimming cutting torch in a direction parallel to the travel way and parallel to the longitudinal direction of the table to a second position in which the second sectioning cutting torch is located offset from the first trimming cutting torch in a direction perpendicular to the travel way and perpendicular to the longitudinal direction of the table such that the second sectioning cutting torch rotates in an arc around the first trimming cutting torch and is simultaneously moved parallel to the longitudinal direction of the travel way and parallel to the longitudinal direction of the table by the movement of the carriage along the travel way.

The second sectioning cutting torch may rotate in a 90° arc or in an arc that is 90°-180° around the first trimming cutting torch.

The boom may include a track extending along a length of the boom and a torch carrier that travels along the track, and the cutting torch assembly is attached to the torch carrier, such that the cutting torch assembly moves in a direction parallel to the boom, perpendicular to the travel way, and perpendicular to the longitudinal direction of the table.

A rotatable torch shaft may be attached to the motor and extending from the cutting torch assembly in a direction toward the table and perpendicular to the boom, an extension may extend from the rotatable torch shaft in a direction perpendicular to the rotatable torch shaft, and the second sectioning cutting torch may extend from the extension in a direction toward the table and perpendicular to the extension.

The cutting torch assembly may be movable in a direction perpendicular to the boom such that the distance between the first trimming cutting torch and the table and between the second sectioning cutting torch and the table may be changed. Alternatively, the first trimming cutting torch and/or the second sectioning cutting torch may be independently movable within the cutting torch assembly in a direction perpendicular to the boom so that the distance between the first trimming cutting torch and the table and/or between the second sectioning cutting torch and the table may be changed.

The trimming and sizing apparatus may further comprise a plurality of cutting torch assemblies, each cutting torch assembly independently movable along the boom such that material may simultaneously be removed from both longitudinal sides of the metal piece or simultaneously be removed from longitudinal sides of more than one metal piece and may further comprise a plurality of tables.

The trimming and sizing apparatus may further comprise a deburring assembly located on an opposite side of the table from the cutting assembly, wherein the deburring assembly comprises a carriage that travels along the travel way on which the cutting assembly travels or along another travel way extending parallel to the travel way on which the cutting assembly travels, a boom extending from the carriage in a direction perpendicular to the travel way, and a deburring head extending from the boom.

The deburring head may be mechanical and remove a burr that forms at a slit created in the metal piece by the first trimming cutting torch by scraping the metal piece. Alternatively, the deburring head may comprise at least one nozzle that directs a gas stream at a burr that forms at a slit created in the metal piece by the first trimming cutting torch. The gas stream exiting the at least one nozzle may be directed toward a breakthrough point at a leading edge of the slit created in the metal piece by the first trimming cutting torch.

The boom of the deburring assembly may include a track extending along a length of the boom of the deburring assembly and a carrier that travels along the track, and the deburring head may be attached to the carrier, such that the deburring head moves in a direction parallel to the boom, perpendicular to the travel way, and perpendicular to the longitudinal direction of the table. The deburring head may be movable in a direction perpendicular to the boom of the deburring assembly such that a distance between the deburring head and the table may be changed.

The deburring head may be positioned behind the first trimming cutting torch relative to the travel direction of the deburring assembly and the cutting assembly along the travel way.

The trimming and sizing apparatus may comprise a plurality of cutting torch assemblies and a corresponding plurality of deburring heads, each cutting torch assembly and each deburring head independently movable along the respective booms such that material may simultaneously be removed from both longitudinal sides of the metal piece or simultaneously be removed from longitudinal sides of more than one metal piece.

Also, the present invention relates to a method of cutting a metal piece using the trimming and sizing apparatus. A metal piece that is substantially rectangular is placed on the table. The carriage is traversed along the travel way such that the cutting torch assembly is moved in a direction parallel to the longitudinal direction of the table. The first trimming cutting torch makes a longitudinal cut in the metal piece which removes a scrap piece from a longitudinal edge of the metal piece as the cutting assembly is moved in the direction parallel to the longitudinal direction of the table. At predetermined intervals during the movement of the cutting torch assembly and simultaneous with the cutting of the metal piece by the first trimming cutting torch, the second sectioning cutting torch is lit and rotated in an arc around the first trimming cutting torch such that the second sectioning cutting torch is simultaneously moved in the longitudinal direction and in an arc around the first trimming cutting torch. As the second sectioning cutting torch is moved in this manner, the second sectioning cutting torch creates a cut in the scrap piece that is formed as the first trimming cutting torch cuts the metal piece such that a sized scrap piece having a desired length or weight is completely removed from the scrap piece. When the sized scrap piece has been completely removed from the scrap piece, the second cutting torch is extinguished. After the predetermined interval has passed, the second sectioning cutting torch is relit and rotated to cut a second sized scrap piece.

As shown in FIG. 17, the sized scrap piece has a shape that is substantially a parallelogram with two opposing first parallel sides and two opposing second parallel sides, wherein the second parallel sides extend diagonally between the first parallel sides.

The rotation of the second sectioning cutting torch may start in a position in which the second sectioning cutting torch is in a position that is offset from and behind the first trimming cutting torch in the travel direction of the first trimming cutting torch and may end when a cut has been made in the scrap piece that extends from the cut made by the first trimming cutting torch to a longitudinal edge of the metal piece. Alternatively, the rotation of the second sectioning cutting torch may start with the second sectioning cutting torch in a position that is offset from the first trimming cutting torch and aligned with a longitudinal edge of the metal piece and end when the second sectioning cutting torch is located in a position that is offset from and behind the first trimming cutting torch in a travel direction of the first trimming cutting torch.

### BRIEF DESCRIPTION OF THE DRAWINGS

FIG. 1 is a front view of the inventive trimming and sizing apparatus.

FIG. 2 is a partial left front perspective view of the inventive trimming and sizing apparatus of FIG. 1.

FIG. 3 is a partial left front perspective view of the inventive trimming and sizing apparatus of FIG. 1.

FIG. 4 is a partial front view of the inventive trimming and sizing apparatus of FIG. 1.

FIG. 5 is a partial front view of the inventive trimming and sizing apparatus of FIG. 1.

FIG. 6 is a partial rear view of the inventive trimming and sizing apparatus of FIG. 1.

FIG. 7 is a front view of the cutting torch assembly of the inventive trimming and sizing apparatus of FIG. 1.

FIG. 8 is a front view of the inventive cutting torch assembly.

FIG. 9 is a side view of the inventive cutting torch assembly.

FIG. 10 is a top view of the inventive cutting torch assembly.

FIG. 11 is a front view of the inventive sectioning cutting torch.

FIG. 12 is a side view of the inventive sectioning cutting torch of FIG. 11.

FIG. 13 is a cross-sectional side view of the inventive sectioning cutting torch of FIG. 11.

FIG. 14 is an expanded cross-sectional side view of the pivoting device designated B in FIG. 13.

FIG. 15 is a right side perspective view of the inventive sectioning cutting torch of FIG. 11.

FIG. 16 is a top view of the inventive sectioning cutting torch of FIG. 11.

FIG. 17 is a top view of the sized scrap piece produced by the inventive trimming and sizing apparatus.

### DESCRIPTION OF THE INVENTION

For purposes of the description hereinafter, the terms “end”, “upper”, “lower”, “right”, “left”, “vertical”, “horizontal”, “top”, “bottom”, “lateral”, “longitudinal”, “proximal”, “distal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting. As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1. Plural encompasses singular and vice versa. When ranges are given, any endpoints of those ranges and/or numbers within those ranges can be combined with the scope of the present invention. “Including”, “such as”, “for example” and like terms means “including/such as/for example but not limited to”.

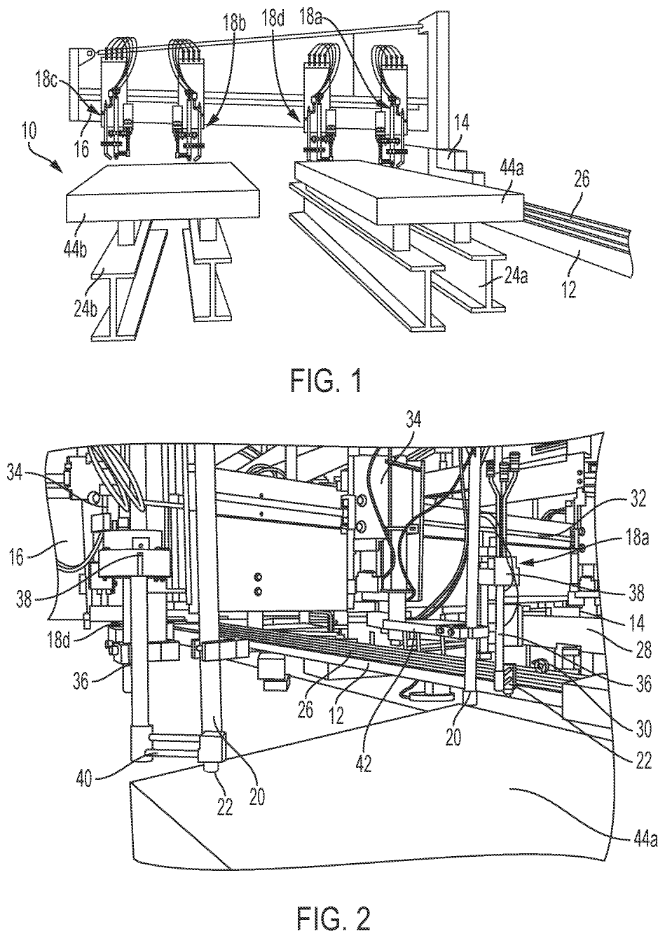

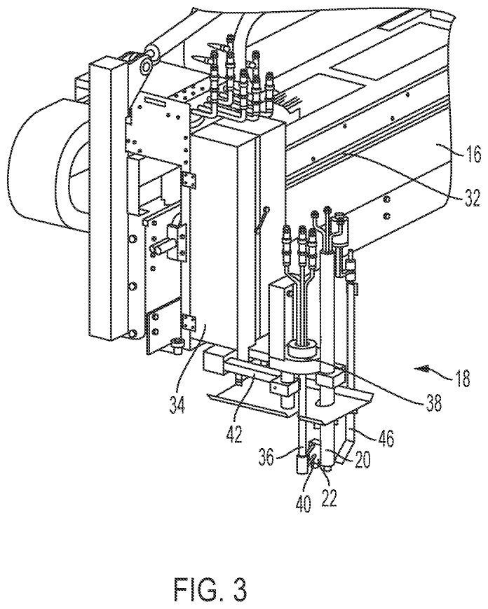

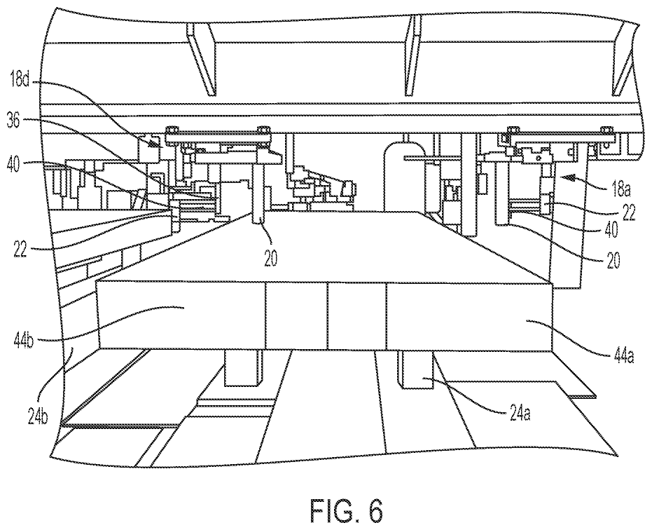

As shown in FIGS. 1-6, the trimming and sizing apparatus 10 comprises: a travel way 12, a cutting assembly, and at least one table 24 for holding the metal piece 44 that is being cut.

The table 24 may be substantially rectangular such that the table 24 is longer in the longitudinal direction than in the transverse direction. The travel way 12 extends parallel to the longitudinal direction of the table 24.

The cutting assembly comprises a carriage 14 that travels along the travel way 12, a boom 16 extending from the carriage 14, and at least one cutting torch assembly 18 comprising a first trimming cutting torch 20 and a second sectioning cutting torch 22.

The carriage 14 is mounted on the travel way 12 and movable with respect to the travel way 12 such that the carriage 14 can be moved from one end of the travel way 12 to the other end of the travel way 12 parallel to the longitudinal direction of the table 24.

The travel way 12 may have at least one track 26. The track 26 of the travel way 12 extends in a direction parallel to the longitudinal direction of the table 24.

The carriage 14 comprises a support platform 28 having wheels 30 attached to the lower side. The wheels 30 are adapted to run along the track 26 of the travel way 12.

The boom 16 includes a track 32 extending along the length of the boom 16 and a torch carrier 34 that travels along the track 32 of the boom 16. The cutting torch assembly 18 is attached to the torch carrier 34. The boom 16 extends from the carriage 14 in a direction perpendicular to the travel way 12 and perpendicular to the longitudinal direction of the table 24. The torch carrier 34 is movable along the track 32 of the boom 16 to allow the cutting torch assembly 18 to move in direction parallel to the boom 16, perpendicular to the travel way 12, and perpendicular to the longitudinal direction of the table 24.

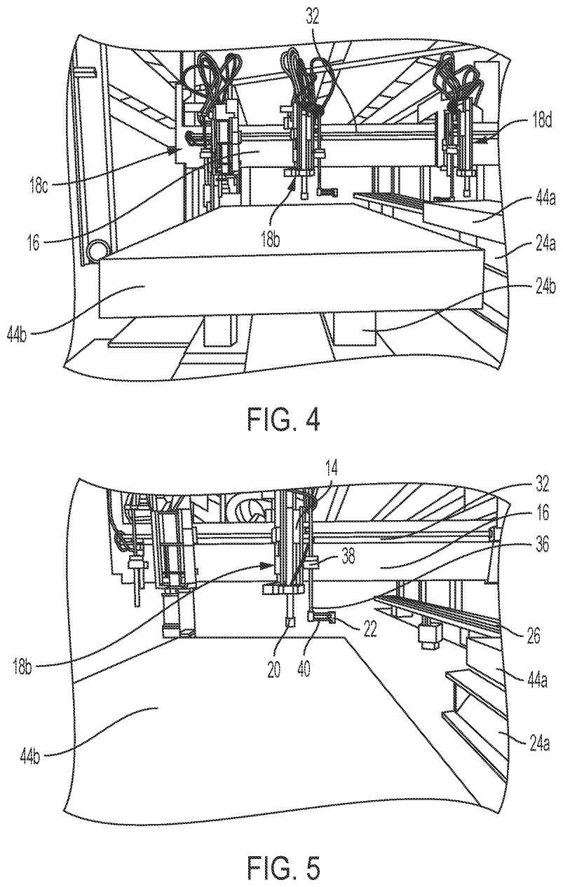

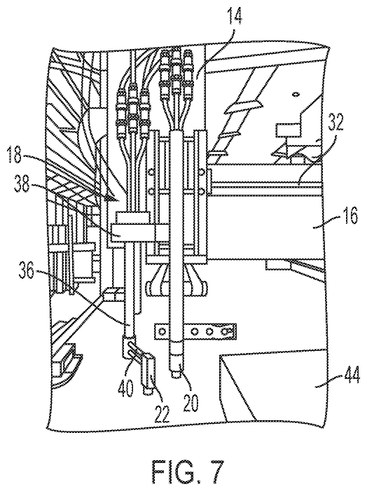

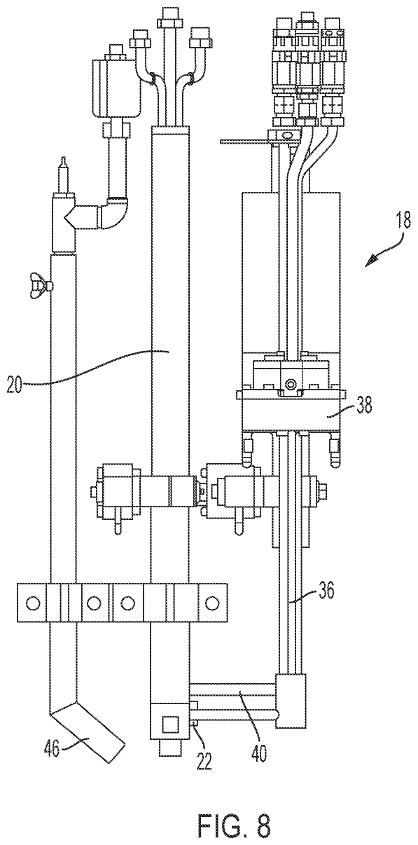

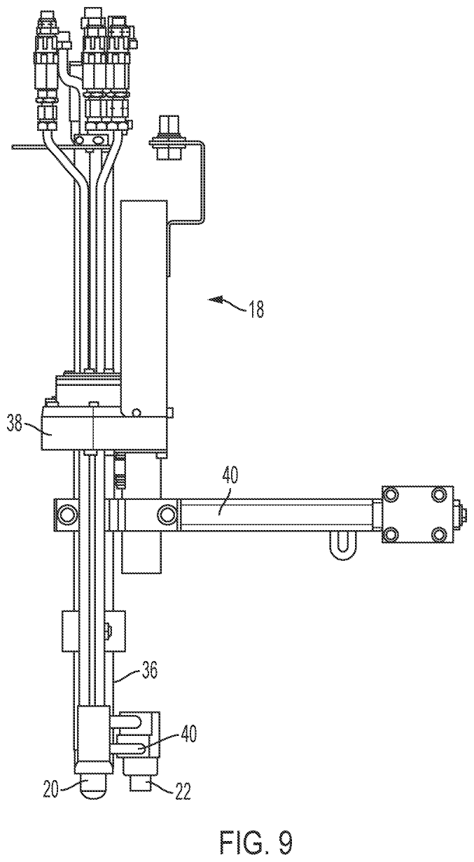

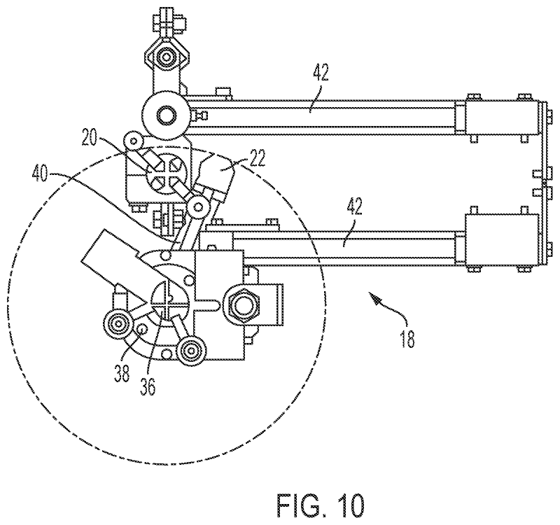

As shown in FIGS. 4-10, the first trimming cutting torch 20 extends from the cutting torch assembly 18 toward the table 24 in a direction that is perpendicular to the boom 16 such that the flame exiting the first trimming cutting torch 20 will contact and cut a metal piece 44 lying on the table 24. The first trimming cutting torch 20 moves in a direction that is parallel to the travel way 12 and parallel to the longitudinal direction of the table 24 as the carriage 14 moves along the travel way 12. The first trimming cutting torch 20 moves in a direction that is perpendicular to the travel way 12 and perpendicular to the longitudinal direction of the table 24 as the torch carrier 34 moves along the boom 16. The cutting torch assembly 18 or a portion of the cutting torch assembly 18 may also be movable in the vertical direction perpendicular to the boom 16 such that the position of the tip of the first trimming cutting torch 20 can be raised or lowered to change the distance between the tip of the first trimming cutting torch 20 and the table 24.

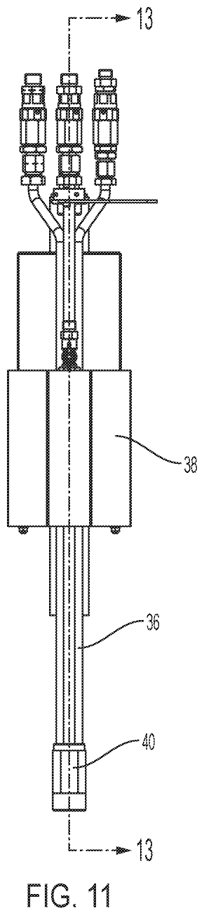

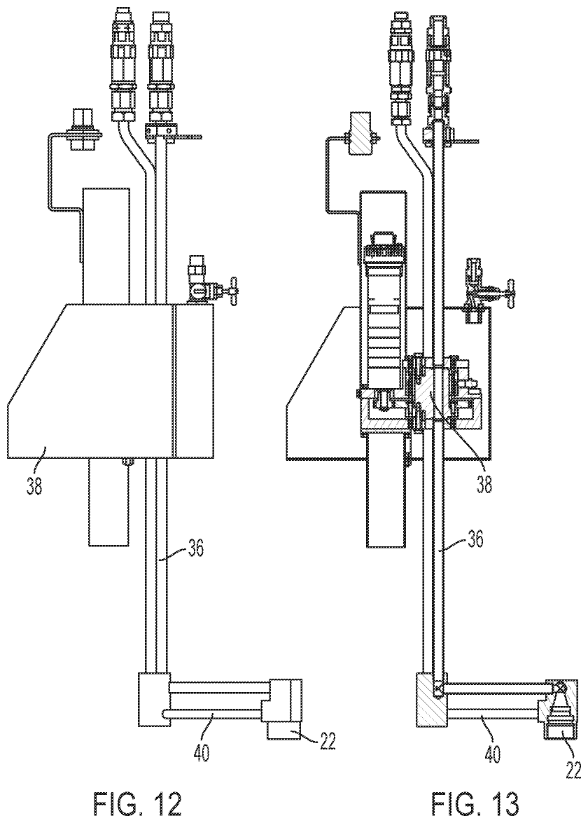

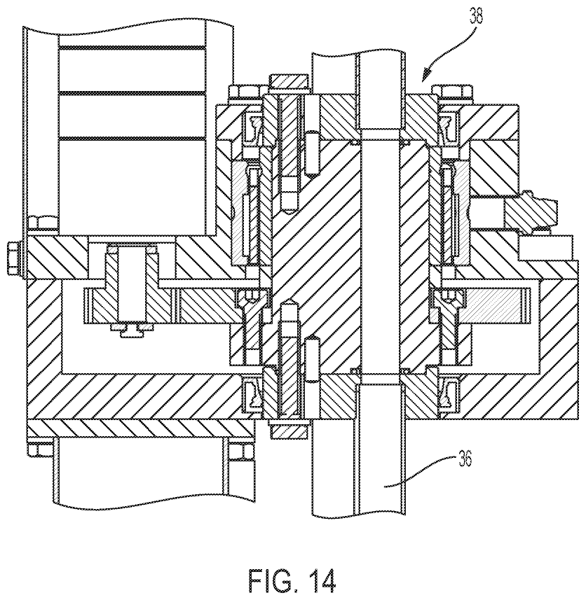

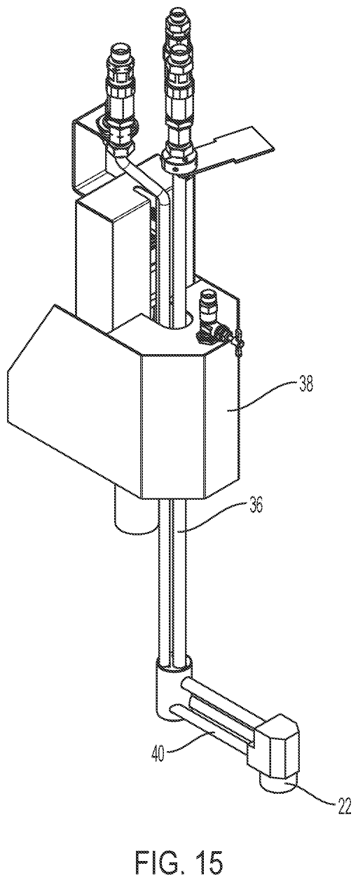

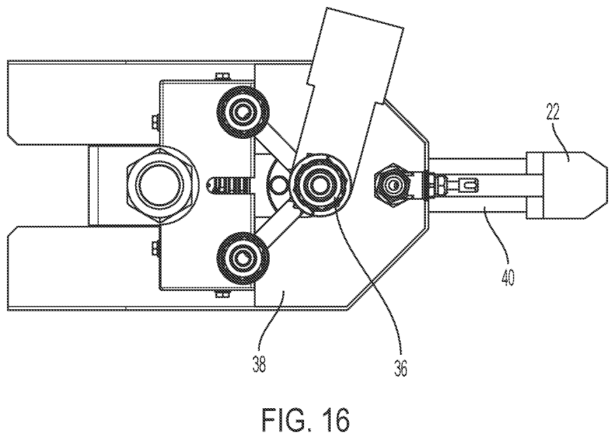

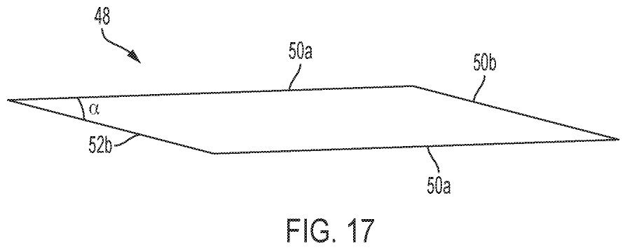

As shown in FIGS. 4-16, a rotatable torch shaft 36 extends from the cutting torch assembly 18 in a direction toward the table 24 and perpendicular to the boom 16, an extension 40 extends from the rotatable torch shaft 36 in a direction perpendicular to the rotatable torch shaft 36, and the second sectioning cutting torch 22 extends from the extension 40 in a direction toward the table 24 and perpendicular to the extension 40. The rotatable torch shaft 36 is moved in a direction that is parallel to the travel way 12 and parallel to the longitudinal direction of the table 24 as the carriage 14 moves along the travel way 12. The rotatable torch shaft 36 is also moved in a direction that is perpendicular to the travel way 12 and perpendicular to the longitudinal direction of the table 24 as the torch carrier 34 moves along the boom 16.

The rotatable torch shaft 36 is connected to a pivoting device 38 that causes the rotatable torch shaft 36 to rotate thereby pivoting the second sectioning cutting torch 22 around the first trimming cutting torch 20. The pivoting device 38 may include any suitable mechanism for rotating the rotatable torch shaft 36, for example, a motor.

The second sectioning cutting torch 22 can be rotated from a first position in which the second sectioning cutting torch 22 is located offset from and behind the first trimming cutting torch 20 in a direction parallel the travel way 12 and parallel to the longitudinal direction of the table 24 to a second position in which the second sectioning cutting torch 22 is located offset from the first trimming cutting torch 20 in a direction perpendicular to the travel way 12 and perpendicular to the longitudinal direction of the table 24. As the second sectioning cutting torch 22 is rotated from the first position to the second position, the travel way of the second sectioning cutting torch 22 covers a 90° arc from the position offset from and behind the first trimming cutting torch 20 in a direction parallel to the travel way 12 and parallel to the longitudinal direction of the table 24 to the position offset from the first trimming cutting torch 20 in a direction perpendicular to the travel way 12 and perpendicular to the longitudinal direction of the table 24. The rotatable torch shaft 36 may be rotated in a clockwise or a counterclockwise direction such that the second sectioning cutting torch 22 may be rotated from the first position to the second position or from the second position to the first position.

Alternatively, the second sectioning cutting torch 22 may be rotated in an arc of more than 90°, for example, an arc of greater than 90° and less than or equal to 180°.

The cutting torch assembly 18 may be movable in a vertical direction perpendicular to the boom 16 such that the distance between the first trimming cutting torch 20 and the second sectioning cutting torch 22 and the table 24 may be changed. Alternatively, the first trimming cutting torch 20 and/or the second sectioning cutting torch 22 may be movable within the cutting torch assembly 18 in a direction perpendicular to the boom 16 so that the distance between the first trimming cutting torch 20 and/or the second sectioning cutting torch 22 and the table 24 may be independently changed.

The cutting torch assembly 18 includes a torch ignitor 46, and may be connected to the torch carrier 34 by one or more extension beams 42 that extend perpendicular to the boom 16 and parallel to the table 24. The first trimming cutting torch 20 and the second sectioning cutting torch 22 may extend from the extension beams 42 toward the table 24.

In operation, a metal piece 44 that is substantially rectangular is placed on the table 24. The longitudinal (long) edges and/or transverse (short) edges of the metal piece 44 may be detected by any suitable sensor attached to the boom 16, for example, a laser may be used for sensing the edges of the metal piece 44. The carriage 14 is traversed along the travel way 12 such that the cutting torch assembly 18, which includes the first trimming torch 20 and the second sectioning torch 22, is moved in a direction parallel to the longitudinal direction of the metal piece 44. As the first trimming cutting torch 20 is traversed in this manner, a longitudinal cut is made in the metal piece 44 by the first trimming cutting torch 20, resulting in a long narrow piece of scrap material being removed from the longitudinal edge of the metal piece 44 which reduces the width of the metal piece 44 in the transverse direction.

As the carriage 14 traverses along the travel way 12, the second sectioning cutting torch 22 is also moved in a direction parallel to the longitudinal direction of the table 24. At predetermined intervals during the movement of the first trimming cutting torch 20 and the second sectioning cutting torch 22 in the longitudinal direction and simultaneous with the cutting of the metal piece 44 by the first trimming cutting torch 20, the second sectioning cutting torch 22 is lit and rotated in an arc around the first trimming cutting torch 20 such that the second sectioning cutting torch 22 is simultaneously moved in the longitudinal direction by the movement of the carriage 14 along the travel way 12 and in an arc around the first trimming cutting torch 20. As the second sectioning cutting torch 22 is moved in this manner, the second sectioning cutting torch 22 creates a cut in the long, narrow piece of scrap metal that is created as the first trimming cutting torch 20 cuts the metal piece 44.

The rotation of the second sectioning cutting torch 22 may start with the second sectioning cutting torch 22 in a position that is offset from and behind the first trimming cutting torch 20 in the travel direction of the first trimming cutting torch 20. The rotation of the second sectioning cutting torch 22 may end when a cut has been made in the long, narrow metal scrap piece that extends from the cut made by the first trimming cutting torch 20 to the original longitudinal edge of the metal piece 44 being cut such that a piece of scrap metal having a desired length or weight is completely removed from the long, narrow metal scrap piece and the metal piece 44 being cut and falls to the ground. The rotation of the second sectioning cutting torch 22 may continue after the piece of scrap metal has been completely removed from the metal piece 44 being cut. After the second sectioning cutting torch 22 has completed the cutting necessary to remove the piece of scrap metal having the desired length or weight from the long, narrow metal scrap piece and the metal piece 44 being cut, the second sectioning cutting torch is extinguished.

Alternatively, the rotation of the second sectioning cutting torch 22 may start with the second sectioning cutting torch 22 in a position that is offset from the first trimming cutting torch 20 and aligned with the original longitudinal edge of the metal piece 44 being cut. The rotation of the second sectioning cutting torch 22 may end when the second sectioning cutting torch 22 is located in a position that is offset from and behind the first trimming cutting torch 20 in the travel direction of the first trimming cutting torch 20. As the second sectioning cutting torch 22 rotates from the starting position to the ending position, a cut is made in the long, narrow metal scrap piece that extends from the original longitudinal edge of the metal piece 44 being cut to the cut made by the first trimming cutting torch 20 such that a piece of scrap metal having a desired length or weight is completely removed from the long, narrow metal scrap piece and the metal piece 44 being cut and falls to the ground. The rotation of the second sectioning cutting torch 22 may continue after the piece of scrap metal has been completely removed from the metal piece 44 being cut.

After the second sectioning cutting torch 22 has completed the cutting necessary to remove the piece of scrap metal having the desired length or weight from the long, narrow metal scrap piece and the metal piece 44 being cut, the second sectional cutting torch is extinguished. The predetermined intervals at which the second sectioning cutting torch 22 is lit and rotated may be selected such that the weight or size of the removed pieces of scrap metal is controlled. Between each rotation of the second sectioning cutting torch 22, the second sectioning cutting torch 22 is extinguished and continues to move in the longitudinal direction as the carriage 14 continues to move along the travel way 12. The first trimming cutting torch 20 remains lit and continues to cut the metal piece 44 in a direction parallel to the longitudinal direction of the metal piece 44. The distance that the first trimming cutting torch 20 and the unlit second sectioning cutting torch 22 travel before the second sectioning cutting torch 22 is lit again and rotated around the first trimming cutting torch 20 determines the length of the piece of scrap metal that will be removed from the long, narrow metal scrap piece that is created as the first trimming cutting torch 20 cut the metal piece 44.

After the second sectioning cutting torch 22 has completed a first rotation to remove a first piece of scrap metal from the long, narrow metal scrap piece and the metal piece 44 being cut, the second sectioning cutting torch 22 may then be rotated in the opposite direction to the starting position prior to making the next cut or may remain in the ending position. If the second sectioning cutting torch 22 remains in the ending position, the second sectioning cutting torch 22 is then rotated in the opposite direction during the next cut.

In this manner, the long, narrow piece of scrap created during the longitudinal cutting of the metal piece 44 is simultaneously cut into smaller more manageable pieces. The sized pieces 48 have a shape that is substantially a parallelogram with two opposing first parallel sides 50a, 50b and two opposing second parallel sides 52a, 52b. The second parallel sides 52a, 52b extend diagonally between the first parallel sides 50a, 50b at an acute angle a to the first parallel sides. The second parallel sides 52a, 52b may be curved. The second parallel sides 52a, 52b are created by the cutting of the second sectioning cutting torch 22, one of the first parallel sides 50a is made by the cutting of the first trimming cutting torch 20, and the other first parallel sides 50b is the original edge of the metal piece 44.

At any time during the cutting, the first trimming cutting torch 20 and/or the second sectioning cutting torch 22 may also be moved in a direction perpendicular to the boom 16 to adjust the distance between the first trimming cutting torch 20 and/or the second sectioning cutting torch 22 and the metal piece 44 that is being cut.

The trimming and sizing apparatus 10 may include more than one cutting torch assembly 18. In operation, a first cutting torch assembly 18a may be used to remove material along one longitudinal side of the metal piece 44 being cut and a second cutting torch assembly 18b may be used to remove material along the other longitudinal side of the metal piece 44 being cut.

The trimming and sizing apparatus 10 may include more than one table 24 and more than one cutting torch assembly 18. In operation, a first cutting torch assembly 18a may be used to remove material along one longitudinal side of a first metal piece 44a on a first table 24a and another cutting torch assembly 18b may be used to simultaneously remove material along the longitudinal side of a second metal piece 44b on the second table 24b. In another embodiment, a first cutting torch assembly 18a may be used to remove material along one longitudinal side of a metal piece 44a on the first table 24a, a second cutting torch assembly 18d may be used to remove material along the other longitudinal side of the metal piece 44a on the first table 24a, a third cutting assembly 18b may be used to remove material along one longitudinal side of a metal piece 44b on the second table 24b, and a fourth cutting torch assembly 18c may be used to remove material along the other longitudinal side of the metal piece 44b on the second table 24b.

The first trimming cutting torch 20 and the second sectioning cutting torch 22 may be oxygen-gas cutting torches.

The trimming and sizing apparatus may further include a deburring assembly as shown in U.S. Pat. Nos. 7,806,029 and 8,402,868 and United States Patent Application Publication Nos. 2017/0129119 and 2019/0118400, which are incorporated herein in their entireties by reference.

The deburring assembly is located on the opposite side of the table 24 from the cutting assembly and has a structure that corresponds to the structure that performs the trimming function except that the deburring assembly includes a deburring head, instead of a cutting torch assembly 18. The deburring head is directed upwardly toward the bottom of the metal piece 44. The corresponding structure of the deburring assembly provides for movement of the deburring head in the same direction relative to the metal piece 44 as the cutting torch assembly 18.

The deburring head is mounted to a carriage that travels along the travel way 12 or a parallel travel way. A boom extends from the carriage. The boom includes a track extending along the length of the boom and a carrier that travels along the track of the boom. The deburring head is attached to the carrier. The boom extends from the carriage in a direction perpendicular to the travel way 12 and perpendicular to the longitudinal direction of the table 24. The carrier is movable along the track of the boom to allow the deburring head to move in direction parallel to the boom, perpendicular to the travel way 12, and perpendicular to the longitudinal direction of the table 24.

The deburring head extends from the deburring assembly in an upward direction that is perpendicular to the boom such that the deburring head is directed toward the bottom side of the metal piece 44 while the first trimming cutting torch 20 is directed toward the top side of the metal piece 44. Any burr created by the cutting of the metal piece 44 by the first trimming cutting torch 20 is removed by the deburring head. The deburring head moves in a direction that is parallel to the travel way 12 and parallel to the longitudinal direction of the table 24 as the carriage moves along the travel way 12. The deburring head moves in a direction that is perpendicular to the travel way 12 and perpendicular to the longitudinal direction of the table 24 as the carrier moves along the boom. The deburring head may also be movable in the vertical direction perpendicular to the boom such that the position of the deburring head can be raised or lowered to change the distance between the deburring head and the table 24.

The travel way 12 may have a single track and a single carriage to which both the boom 16 for the cutting torch assembly 18 and the boom for the deburring assembly are attached. In this configuration, the carriage, the boom 16 for the cutting torch assembly 18, and the boom for the deburring assembly form a U-shape that defines a channel in which the metal piece 44 is received. Because the cutting assembly and the deburring assembly are coupled to a common carriage, they move in unison along the travel way 12.

Alternatively, the cutting torch assembly and the deburring assembly may be coupled to separate carriages that run along the same or separate tracks on the travel way 12. Although the cutting torch assembly and the deburring assembly may travel along the travel way 12 in unison, because the cutting torch assembly and the deburring assembly are coupled to separate carriages, they are able to travel independently of one another along the travel way 12.

The deburring head may be mechanical and remove the burr that forms at the slit created in the metal piece 44 by the first trimming cutting torch 20 by scraping the bottom side of the metal piece 44.

Alternatively, the deburring head may direct a gas stream at the burr that forms at the slit created in the metal piece 44 by the first trimming cutting torch 20. This deburring head may comprise a manifold and at least one nozzle through which the gas is directed at the bottom of the metal piece. The gas may include oxygen and/or an inert gas.

The deburring head may be positioned behind the first trimming cutting torch 20 relative to the travel direction of the deburring assembly and the cutting assembly along the travel way 12. The gas streams exiting the at least one nozzle may be directed toward a location on the bottom side of the metal piece 44 that corresponds to the location at which the cutting operation is being performed and may be directed particularly toward the breakthrough point at the leading edge of the slit created in the bottom surface of the metal piece 44.

When the device includes more than one cutting torch assembly 18, a corresponding deburring head is provided for each cutting torch assembly 18.

In operation, the deburring head moves in a direction that corresponds to the movement of the cutting torch assembly 18 and any burr created on the bottom side of the metal piece 44 by the first trimming cutting torch 20 is removed by the deburring head.

Although the invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A method of trimming and sizing a metal piece, the method comprising:
a) providing a trimming and sizing apparatus comprising:
a travel way;
a cutting assembly comprising:
a carriage that travels along the travel way;
a boom extending from the carriage in a direction perpendicular to the travel way; and
at least one cutting torch assembly extending from the boom and comprising a first trimming cutting torch and a second sectioning cutting torch; and
at least one table for holding the metal piece that is being cut;
b) placing a metal piece that is substantially rectangular on the table;
c) traversing the carriage along the travel way such that the cutting torch assembly is moved in a direction parallel to a longitudinal direction of the table, wherein the first trimming cutting torch makes a longitudinal cut in the metal piece which removes a scrap piece from a longitudinal edge of the metal piece as the cutting assembly is moved in the direction parallel to the longitudinal direction of the table;
d) at predetermined intervals during the movement of the cutting torch assembly and simultaneous with the cutting of the metal piece by the first trimming cutting torch, lighting the second sectioning cutting torch and rotating the second sectioning cutting torch in an arc around the first trimming cutting torch such that the second sectioning cutting torch is simultaneously moved in the longitudinal direction and in an arc around the first trimming cutting torch, wherein as the second sectioning cutting torch is moved in this manner, the second sectioning cutting torch creates a cut in the scrap piece that is formed as the first trimming cutting torch cuts the metal piece such that a sized scrap piece having a desired length or weight is completely removed from the scrap piece;
e) when the sized scrap piece has been completely removed from the scrap piece, extinguishing the second sectioning cutting torch; and
f) after the predetermined interval has passed, lighting the second sectioning cutting torch and repeating steps d) and e).

2. The method of claim 1, wherein the sized scrap piece has a shape that is substantially a parallelogram with two opposing first parallel sides and two opposing second parallel sides, wherein the second parallel sides extend diagonally between the first parallel sides.

3. The method of claim 1, wherein the rotation of the second sectioning cutting torch starts in a position in which the second sectioning cutting torch is in a position that is offset from and behind the first trimming cutting torch in the travel direction of the first trimming cutting torch and ends when a cut has been made in the scrap piece that extends from the cut made by the first trimming cutting torch to a longitudinal edge of the metal piece or the rotation of the second sectioning cutting torch starts with the second sectioning cutting torch in a position that is offset from the first trimming cutting torch and aligned with the longitudinal edge of the metal piece and ends when the second sectioning cutting torch is located in a position that is offset from and behind the first trimming cutting torch in a travel direction of the first trimming cutting torch.

4. The method of claim 1, wherein the second sectioning cutting torch rotates in a 90° arc around the first trimming cutting torch.

5. The method of claim 1, wherein the second sectioning cutting torch rotates in an arc around the first trimming cutting torch that is 90°-180°.

6. The method of claim 1, wherein the cutting torch assembly is movable in a direction perpendicular to the boom such that a distance between the first trimming cutting torch and the table and between the second sectioning cutting torch and the table may be changed.

7. The method of claim 1, wherein the first trimming cutting torch and/or the second sectioning cutting torch are independently movable within the cutting torch assembly in a direction perpendicular to the boom so that a distance between the first trimming cutting torch and the table and/or between the second sectioning cutting torch and the table may be changed.

8. The method of claim 1, wherein the trimming and sizing apparatus comprises a plurality of cutting torch assemblies, each cutting torch assembly independently movable along the boom such that material may simultaneously be removed from both longitudinal sides of the metal piece or simultaneously be removed from longitudinal sides of more than one metal piece.

9. The method of claim 1, wherein the trimming and sizing apparatus further comprises:
a deburring assembly located on an opposite side of the table from the cutting assembly, wherein the deburring assembly comprises:
a carriage that travels along the travel way on which the cutting assembly travels or along another travel way extending parallel to the travel way on which the cutting assembly travels;
a boom extending from the carriage in a direction perpendicular to the travel way; and
a deburring head extending from the boom,
and the method further comprises:
moving the deburring assembly along the travel way on which the cutting assembly travels or along another travel way extending parallel to the travel way on which the cutting assembly travels; and
removing a burr that forms at a slit created in the metal piece by the first trimming cutting torch using the deburring head.

10. The method of claim 9, wherein the deburring head is mechanical and removes the burr by scraping the metal piece.

11. The method of claim 9, wherein the deburring head comprises at least one nozzle that directs a gas stream at the burr and removes the burr via the gas stream.

12. The method of claim 11, wherein the gas stream exiting the at least one nozzle is directed toward a breakthrough point at a leading edge of the slit created in the metal piece by the first trimming cutting torch.

13. The method of claim 9, wherein the boom of the deburring assembly includes a track extending along a length of the boom of the deburring assembly and a carrier that travels along the track, and the deburring head is attached to the carrier, such that the deburring head moves in a direction parallel to the boom, perpendicular to the travel way, and perpendicular to the longitudinal direction of the table.

14. The method of claim 13, wherein the deburring head is movable in a direction perpendicular to the boom of the deburring assembly such that a distance between the deburring head and the table may be changed.

15. The method of claim 9, wherein the trimming and sizing apparatus comprises a plurality of cutting torch assemblies and a corresponding plurality of deburring heads, each cutting torch assembly and each deburring head independently movable along the respective booms such that material may simultaneously be removed from both longitudinal sides of the metal piece or simultaneously be removed from longitudinal sides of more than one metal piece.

16. The method of claim 9, wherein the deburring head is positioned behind the first trimming cutting torch relative to the travel direction of the deburring assembly and the cutting assembly along the travel way.
